(19) United States
(12) Patent Application Publication
(10) Pub. No.: US 2014/0220961 A1
(43) Pub. Date: Aug. 7, 2014

(54) MOBILE DEVICE CONFIGURATION UTILIZING PHYSICAL DISPLAY

(71) Applicant: HTC Corporation, Taoyuan County (TW)

(72) Inventors: Peter POLSON, Seattle, WA (US); Thomas B. HOLMAN, Kent, WA (US); Brett C. TANIS-LIKKEL, Kirkland, WA (US)

(73) Assignee: HTC Corporation, Taoyuan County (TW)

(21) Appl. No.: 14/020,715

(22) Filed: Sep. 6, 2013

Related U.S. Application Data
(60) Provisional application No. 61/761,632, filed on Feb. 6, 2013.

(51) Int. Cl. H04W 8/20; H04W 88/06; H04W 4/00

(52) U.S. Cl. CPC H04W 8/205; H04W 4/008; H04W 88/06
USPC 455/419

(57) ABSTRACT

A configuration display may be used to configure and customize a mobile device. The configuration display may comprise a NFC device or other technologies to associate a string with some or all of the configuration display. The configuration display may further comprise an image associated with a configuration and/or customization option relative to a mobile device. The image may be associated with the string at a server. The mobile device obtains the string and transmits it to the server. The server obtains the associated configuration and/or customization and transmits the configuration and/or customization to the mobile device. The configuration display may be updated.

### FIELD

This disclosure relates to configuration of mobile computing devices.

### BACKGROUND

The following description includes information that may be useful in understanding the present invention. It is not an admission that any of the information provided herein is prior art or relevant to the presently claimed invention, or that any publication specifically or implicitly referenced is prior art.

When mobile computing device customers obtain their mobile device (smart phone, tablet computer, e-reader, laptop computer, etc., hereinafter “Mobile Devices”), they are excited to have new computing hardware and look forward to using the Mobile Device.

However, the Mobile Device must be configured with user accounts, wireless service (comprising phone, data, text, and Wi-Fi service), establishment of or synchronization with existing calendar, contact, email, photograph, and audio and video services, installation of software applications or routines (also referred to herein as “Apps”), customization of “wallpapers” or other background graphics, ringtones, ringbacks, and the like. The configuration process can be cumbersome, can reduce the customer's enthusiasm for the new Mobile Device, and may cause the customer not to keep the new device or not to recommend the Mobile Device or wireless service providers associated with the Mobile Device. The configuration process may go more smoothly if the customization process could be performed on a computing device with a larger display and/or touch screen, a mouse, or other user interface (relative to the input and output modalities found on the Mobile Device), though some or all of the customization process requires that the customization be performed utilizing the newly acquired Mobile Device and the user interface of the Mobile Device.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary Configuration Server computing device and some data structures and/or components thereof.

FIG. 3 is a functional block diagram of the Configuration Server Datastore illustrated in the computing device of FIG. 2.

FIG. 4 is a functional block diagram of an exemplary Display Computer and some data structures and/or components thereof.

FIG. 5 is a functional block diagram of the Display Computer Datastore illustrated in the computing device of FIG. 4.

FIG. 6 is a functional block diagram of an exemplary Mobile Device computing device and some data structures and/or components thereof.

FIG. 7 is a functional block diagram of the Mobile Device Datastore illustrated in the computing device of FIG. 6.

FIG. 8 is an illustration providing an example of a Configuration Display.

FIG. 9 is a flowchart illustrating embodiments of a Configuration Application routine in which a Mobile Device is configured via interaction with a Configuration Display and the Configuration Server.

FIG. 10 is a flowchart illustrating a routine in which a Configuration Server DB Process interacts with a Mobile Device to provide the Mobile Device with Configuration Data.

FIG. 11 is a flowchart illustrating a routine in which a Display Computer configures the Configuration Server and the Configuration Display.

FIG. 12 is a flowchart illustrating a routine in which a Mobile Device interacts with a Configuration Display without mediation of a Configuration Server.

### DETAILED DESCRIPTION

The following Detailed Description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

Certain elements appear in various of the Figures with the same capitalized element text, but a different element number. When referred to herein with the capitalized element text but with no element number, these references should be understood to be largely equivalent and to refer to any of the elements with the same capitalized element text, though potentially with differences based on the computing device within which the various embodiments of the element appears.

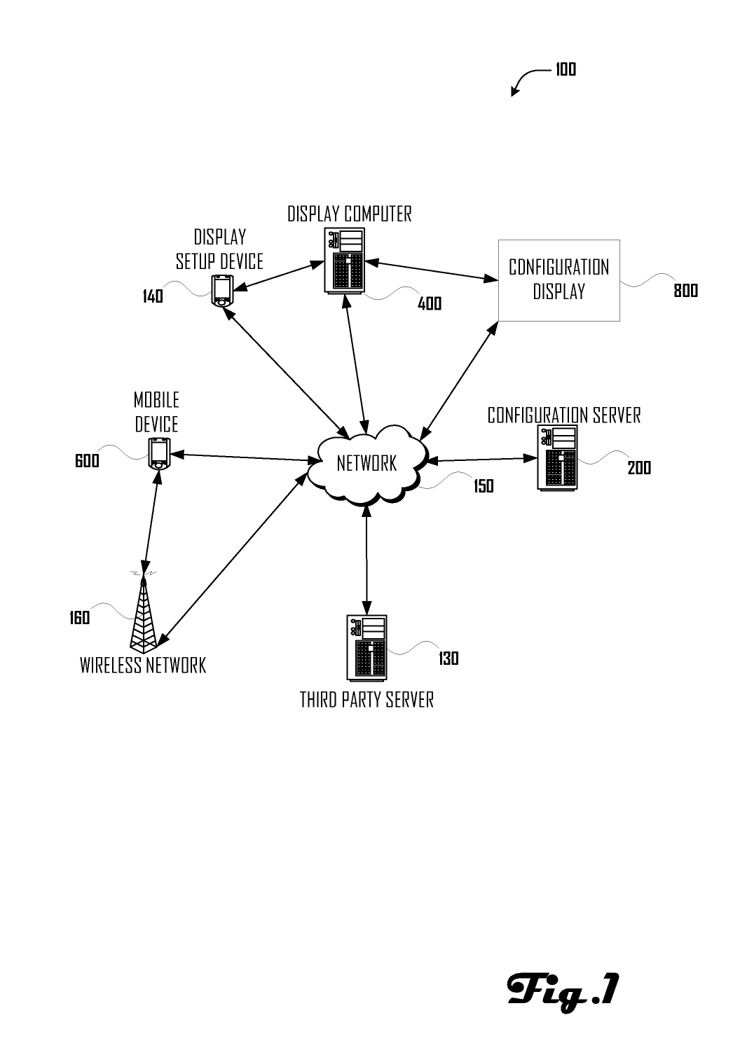

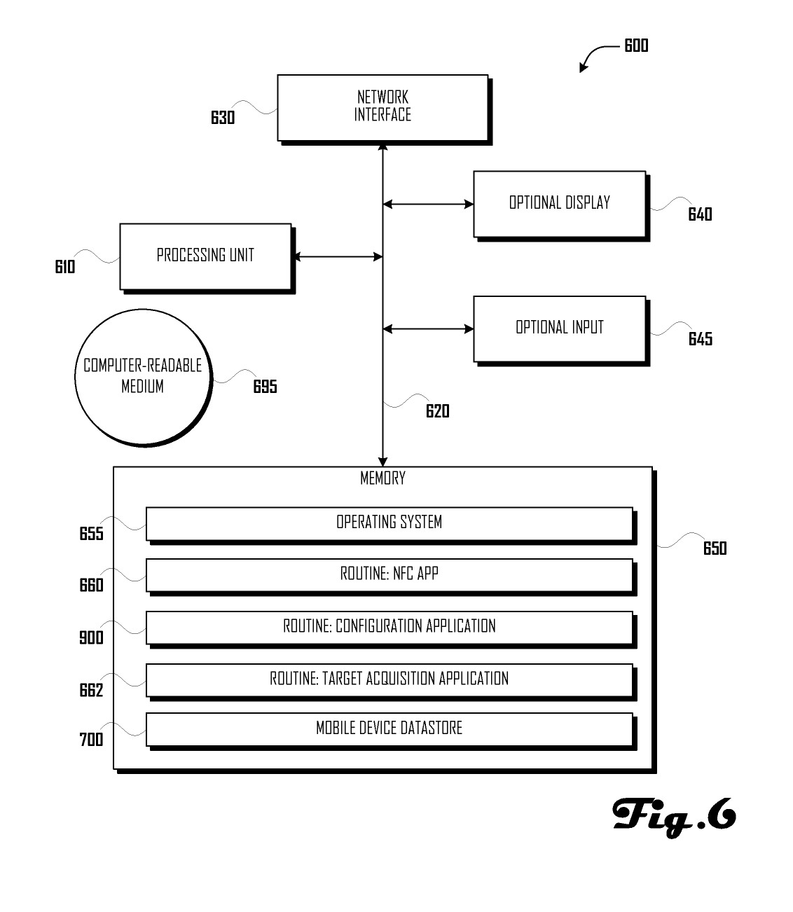

FIG. 1 is a network and device diagram illustrating exemplary computing devices configured according to embodiments disclosed in this paper. In FIG. 1, a Mobile Device 600 computer is illustrated as connecting to a Network 150, such as the Internet (which connection may be via a Wi-Fi connection), and/or to a Wireless Network 160, such as a GSM, TDMA, CDMA, EDGE, HSPA, LTE or other network provided by a wireless service provider. Connection to either network may require that the Mobile Device 600 and network computers execute software routines which enable, for example, the seven layers of the OSI model of computer networking or equivalent in a wireless phone network. The Network 150 and Wireless Network 160 comprise computers, network connections among the computers, and software routines to enable communication between the computers over the network connections. The Mobile Device 600 is used by a customer (not shown) to interact with the Configuration Display 800 and Configuration Server 200. The Mobile Device 600 may be, for example, a smart phone, a tablet computer, an e-reader, a laptop computer, or similar computing device. The Mobile Device 600 is discussed further herein, in relation to FIG. 6.

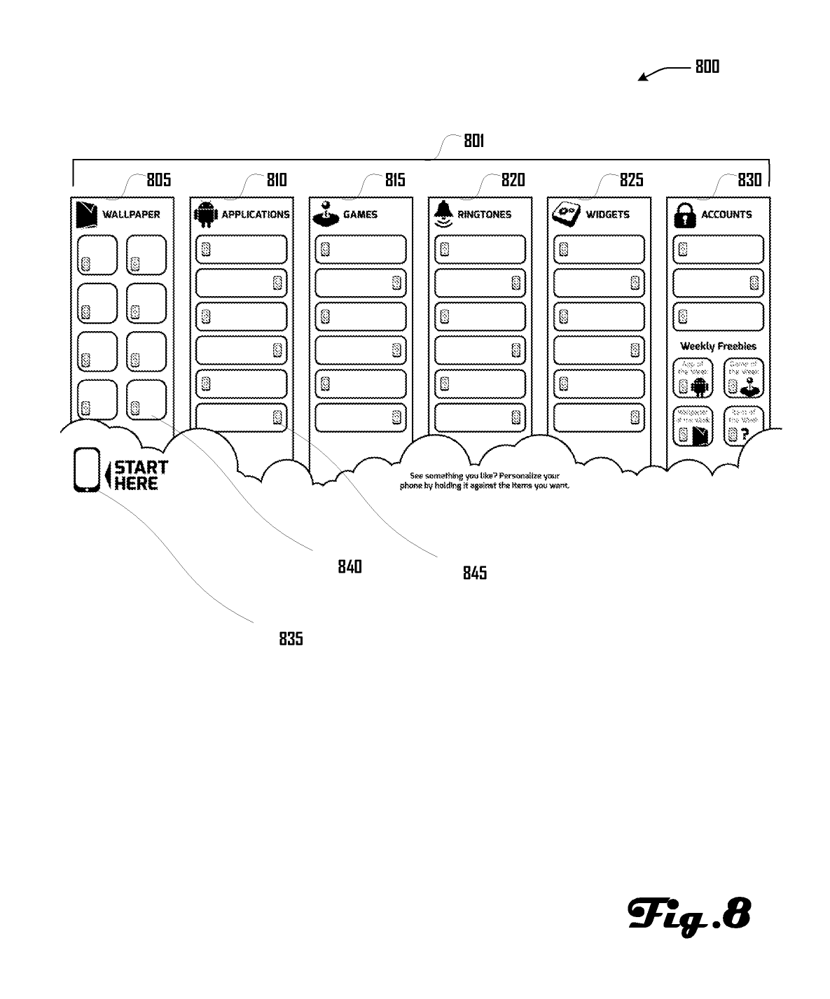

Also illustrated in FIG. 1 is a Configuration Display 800. The Configuration Display 800 is discussed further herein, in relation to FIG. 8.

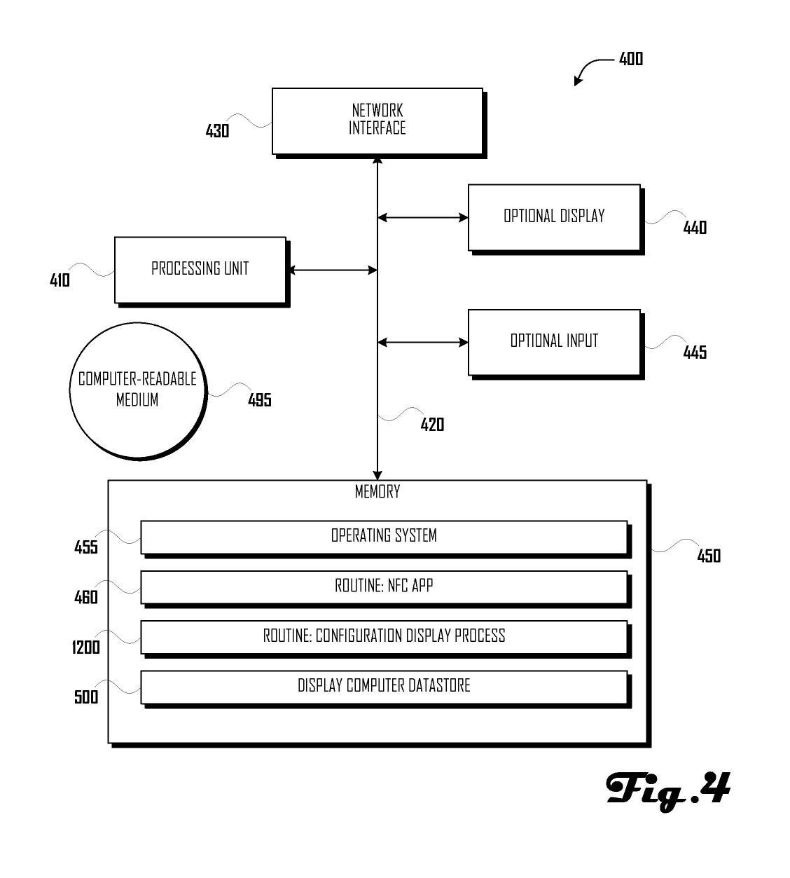

Also illustrated in FIG. 1 is a Display Computer 400. The Display Computer 400 may be utilized to configure, project, or display the Configuration Display 800. The Display Computer 400 is discussed further herein, in relation to FIG. 4.

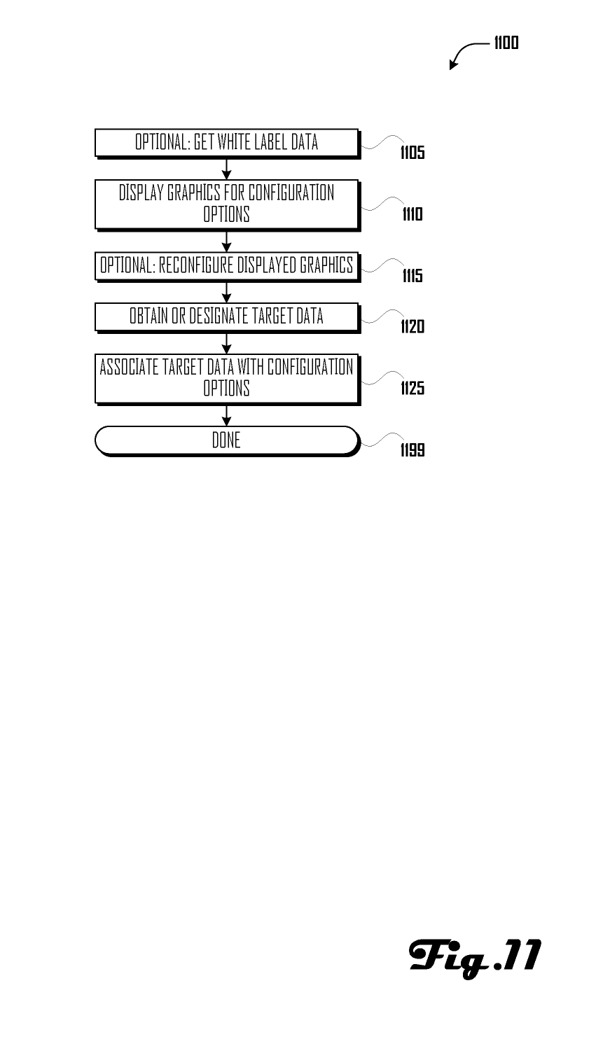

Also illustrated in FIG. 1 is a Display Setup Device 140. The Display Setup Device 140 may be a mobile computing device similar to the Mobile Device 600 or the Display Computer 400 and may include an NFC device and an NFC Application (similar to NFC App 460) and/or a digital camera and a Target Acquisition Application (similar to Target Acquisition Application 662). Use of the Display Setup Device 140 is discussed further herein, in relation to FIG. 11.

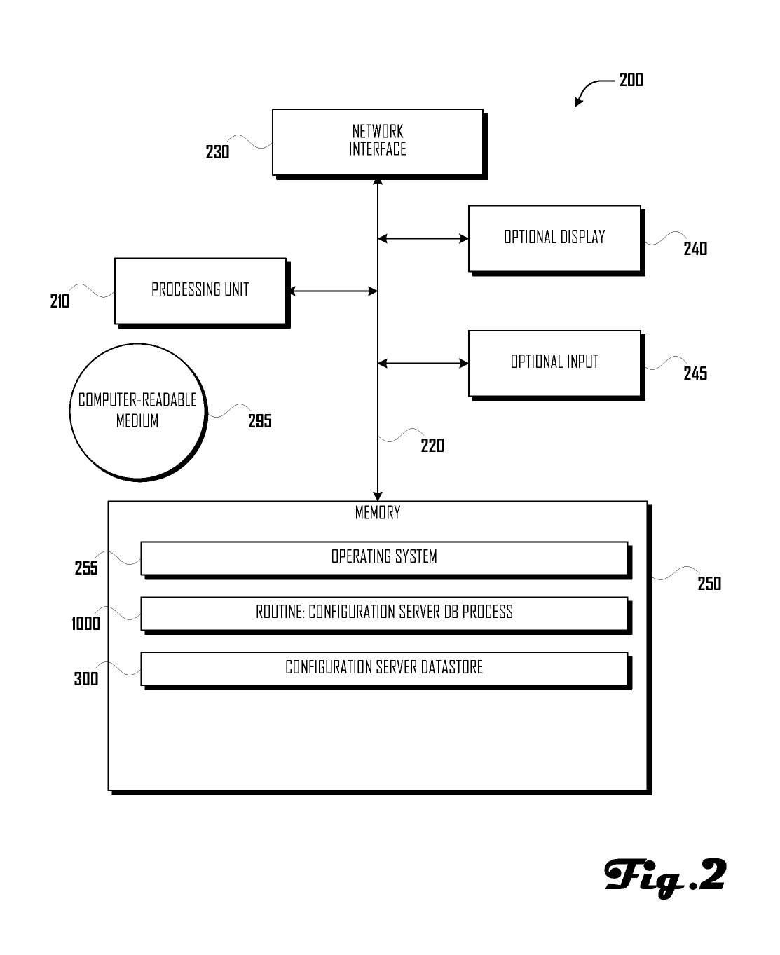

Also illustrated in FIG. 1 is a Third Party Server 130 connected to the Network 150. The Third Party Server 130 represents, for example, online services, such as QR code and barcode processing services, social network services, and other online services. The Third Party Server 130 also represents third parties who may “white label” the services discussed herein as being provided by the Configuration Server 200; such a party may include, for example, the operator of the Wireless Network 160, a party who resells services of a Wireless Network 160, or a party who sells Mobile Devices. The Third Party Server 130 may be implemented by a computer similar to the computer illustrated in FIG. 2.

This paper may discuss a first computer as connecting to a second computer (such as to the Configuration Server 200) or to a corresponding datastore (such as Configuration Server Datastore 300); it should be understood that such connections may be to, through, or via the other of the two components (for example, a statement that a computing device connects with or sends data to the Configuration Server 200 should be understood as saying that the computing device may connect with or send data to the Configuration Server Datastore 300). References herein to “database” should be understood as equivalent to “Datastore.” Although illustrated as components integrated in one physical unit, the servers and databases may be provided by common (or separate) physical hardware and common (or separate) logic processors and memory components.

FIG. 2 is a functional block diagram of an exemplary Configuration Server computing device and some data structures and/or components thereof. The computing device 200 in FIG. 2 comprises at least one Processing Unit 210, memory 250, and an Optional Display 240, all interconnected along with the Network Interface 230 via a Bus 220. The Network Interface 230 may be utilized to form connections with the Network 150. The Memory 250 generally comprises a random access memory (“RAM”), a read only memory (“ROM”), and a permanent mass storage device, such as a disk drive or SDRAM (synchronous dynamic random-access memory). The Memory 250 stores program code for software routines, such as, for example, the routines illustrated in these figures, as well as browser, email client and server routines, client applications, and database applications. In addition, the Memory 250 also stores an Operating System 255. These software components may be loaded from a non-transient Computer Readable Storage Medium 295 into Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

The computing device 200 may also comprise hardware supporting input modalities, Optional Input 245, such as, for example, a touchscreen, a keyboard, a mouse, a trackball, a stylus, a microphone, a camera, and an NFC sensor.

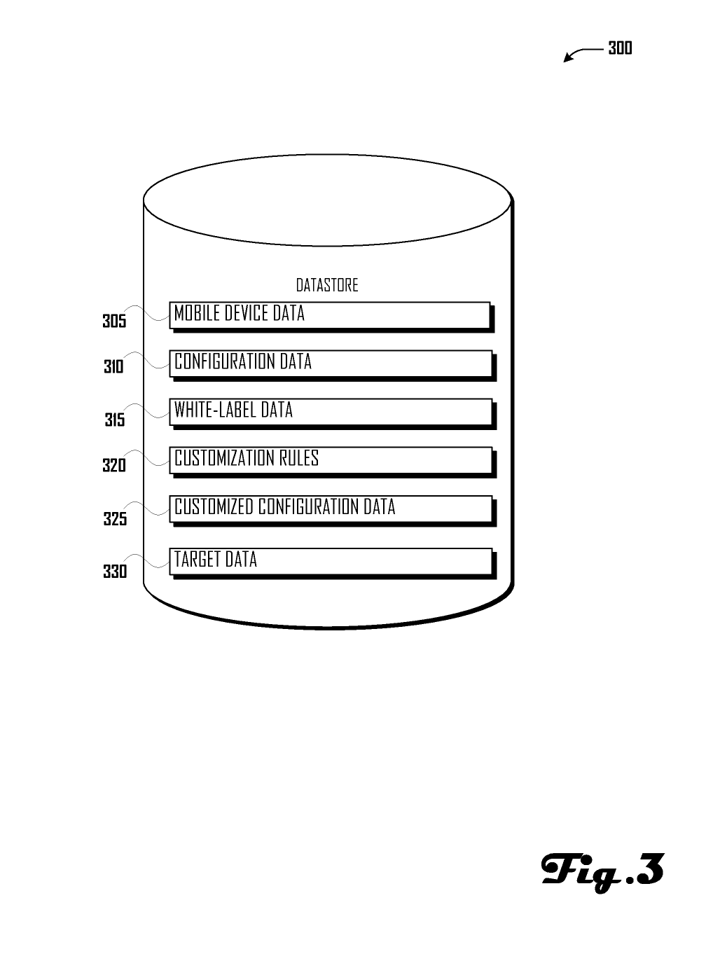

The computing device 200 may also comprise or communicate via Bus 220 with Configuration Server Datastore 300, illustrated further in FIG. 3. In various embodiments, Bus 220 may comprise a storage area network (“SAN”), a high speed serial bus, and/or via other suitable communication technology. In some embodiments, computing device may communicate with the Datastore via Network Interface 230. The computing device 200 may, in some embodiments, include many more components than those shown in this Figure. However, it is not necessary that all of these generally conventional components be shown in order to disclose an illustrative embodiment.

The Configuration Server 200 illustrated in FIG. 2 comprises data groups for routines, such as a routine for a Configuration Database Process 260. The Configuration Database Process 260 is a software routine which maintains the Configuration Server Datastore 300 and provides for interaction between the Mobile Device 600 and the Configuration Server 200, the Display Computer 400 and the Configuration Server 200, and between the Configuration Server 200 and other computing devices discussed in this paper. Additional data groups for routines, such as for a webserver and web browser, may also be present on and executed by these devices. Browser routines may provide an interface for interacting with the other computing devices illustrated in FIG. 1, such as the Mobile Device 600, for example, through a webserver routine (which may serve data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 3 is a functional block diagram of the Configuration Server Datastore illustrated in the computing device of FIG. 2. The components of the Configuration Server Datastore 300 are data groups used by routines and are discussed further herein in the discussion of other of the Figures.

FIG. 4 is a functional block diagram of an exemplary Display Computer and some data structures and/or components thereof. The computing device 400 in FIG. 4 comprises at least one Processing Unit 410, memory 450, and an Optional Display 440, all interconnected along with the Network Interface 430 via a Bus 420. The Network Interface 430 may be utilized for form connections with the Network 150. The Memory 450 generally comprises a random access memory (“RAM”), a read only memory (“ROM”), and a permanent mass storage device, such as a disk drive or SDRAM (synchronous dynamic random-access memory). The Memory 450 stores program code for software routines, such as, for example, the routines illustrated in these figures, as well as browser, email client and server routines, client applications, and database applications. In addition, the Memory 450 also stores an Operating System 455. These software components may be loaded from a non-transient Computer Readable Storage Medium 495 into Memory 450 of the computing device using a drive mechanism (not shown) associated with a non-transient Computer Readable Storage Medium 495, such as a floppy disc, tape, DVD/CD-ROM drive, memory card, or other like storage medium. In some embodiments, software components may also or instead be loaded via a mechanism other than a drive mechanism and Computer Readable Storage Medium 495 (e.g., via Network Interface 430).

The computing device 400 may also comprise hardware supporting input modalities, Optional Input 445, such as, for example, a touchscreen, a keyboard, a mouse, a trackball, a stylus, a microphone, a camera, and an NFC sensor.

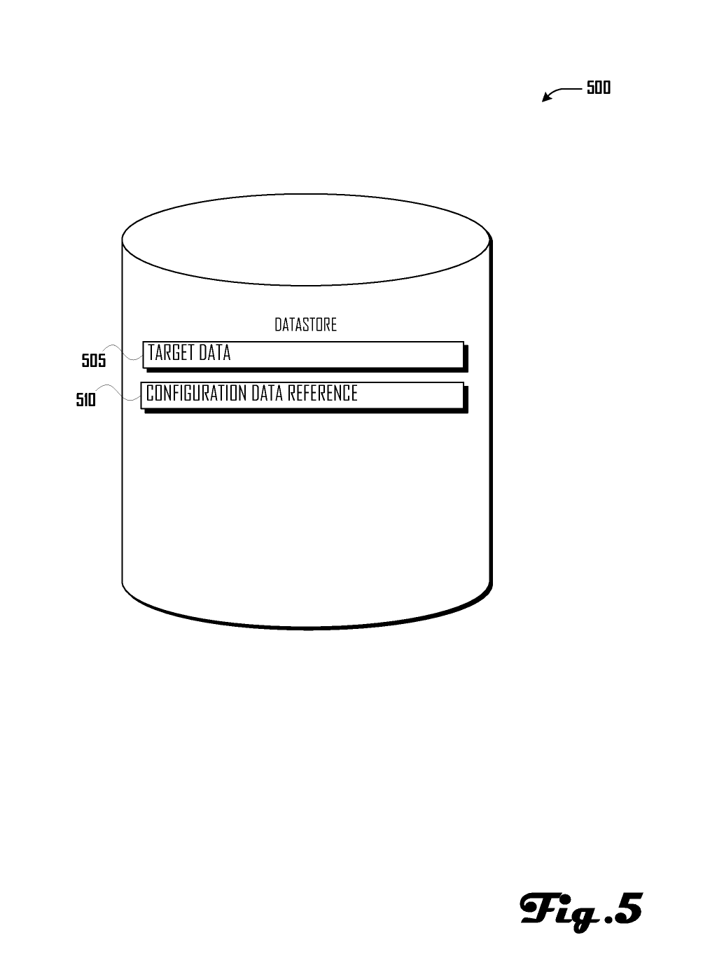

The computing device 400 may also comprise or communicate via Bus 420 with Display Computer Datastore 500, illustrated further in FIG. 5. In various embodiments, Bus 420 may comprise a storage area network (“SAN”), a high speed serial bus, and/or via other suitable communication technology. In some embodiments, computing device may communicate with the Datastore via Network Interface 430. The computing device 400 may, in some embodiments, include many more components than those shown in this Figure. However, it is not necessary that all of these generally conventional components be shown in order to disclose an illustrative embodiment.

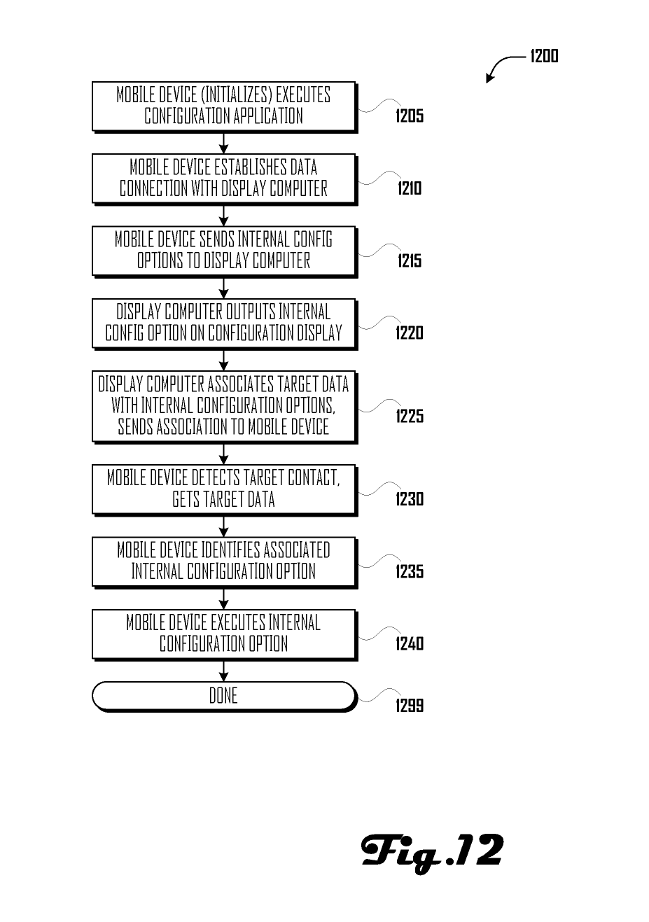

The Display Computer 400 illustrated in FIG. 4 comprises data groups for routines, such as routines for an NFC Application 460 and a Configuration Display Process 1200. The NFC Application 460 is a software routine which provides NFC functions to the Display Computer 200, such as allowing the detection or transmission of NFC codes or strings in Targets, for treating NFC codes as triggers for the execution of other software routines, for modifying NFC codes, or for treating NFC codes as data to be used by other software routines. The NFC Application 460 may be part of the Operating System 455. The NFC Application may always be on or may have to be initiated by, for example, the user of the Mobile Device 600, by another routine, or similar. The Configuration Display Process 1200 is discussed further below in relation to FIG. 12. Additional data groups for routines, such as for a webserver and web browser, may also be present on and executed by these devices. Browser routines may provide an interface for interacting with the other computing devices illustrated in FIG. 1, such as the Configuration Server 200, for example, through a webserver routine (which may serve data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 5 is a functional block diagram of the Display Computer Datastore illustrated in the computing device of FIG. 4. The components of the Display Computer Datastore 500 are data groups used by routines and are discussed further herein in the discussion of other of the Figures.

FIG. 6 is a functional block diagram of an exemplary Mobile Device computing device and some data structures and/or components thereof. The computing device 600 in FIG. 6 comprise at least one Processing Unit 610, memory 650, and an Optional Display 640, all interconnected along with the Network Interface 630 via a Bus 620. The Network Interface 630 may be utilized for form connections with the Network 150. The Memory 650 generally comprises a random access memory (“RAM”), a read only memory (“ROM”), and a permanent mass storage device, such as a disk drive or SDRAM (synchronous dynamic random-access memory). The Memory 650 stores program code for software routines, such as, for example, the routines illustrated in these figures, as well as browser, email client and server routines, client applications, and database applications. In addition, the Memory 650 also stores an Operating System 655. These software components may be loaded from a non-transient Computer Readable Storage Medium 695 into Memory 650 of the computing device using a drive mechanism (not shown) associated with a non-transient Computer Readable Storage Medium 695, such as a floppy disc, tape, DVD/CD-ROM drive, memory card, or other like storage medium. In some embodiments, software components may also or instead be loaded via a mechanism other than a drive mechanism and Computer Readable Storage Medium 695 (e.g., via Network Interface 630).

The computing device 600 may also comprise hardware supporting input modalities, Optional Input 645, such as, for example, a touchscreen, a keyboard, a mouse, a trackball, a stylus, a microphone, a camera, and an NFC sensor.

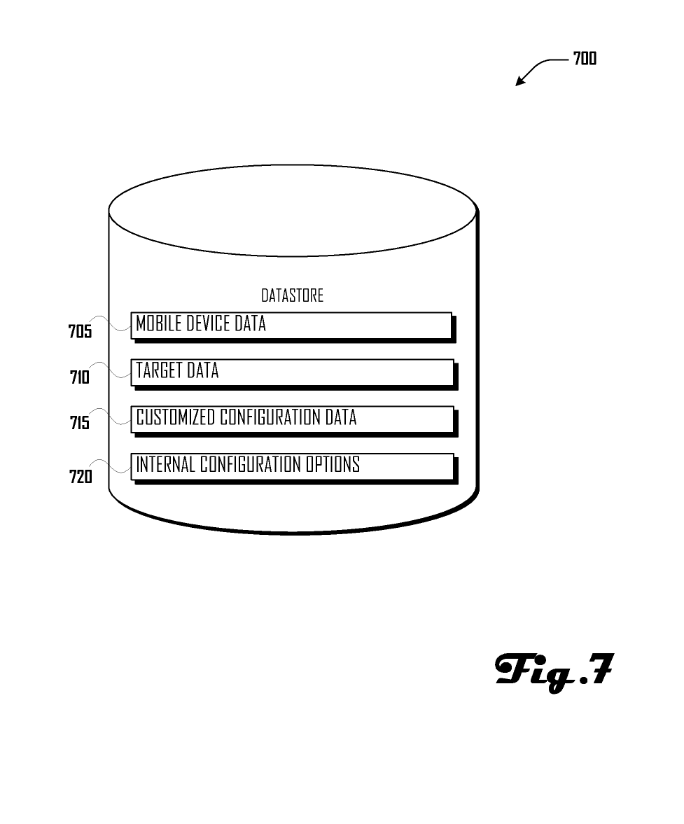

The computing device 600 may also comprise or communicate via Bus 620 with Mobile Device Datastore 700, illustrated further in FIG. 7. In various embodiments, Bus 620 may comprise a storage area network (“SAN”), a high speed serial bus, and/or via other suitable communication technology. In some embodiments, computing device may communicate with the Datastore via Network Interface 630. The computing device 600 may, in some embodiments, include many more components than those shown in this Figure. However, it is not necessary that all of these generally conventional components be shown in order to disclose an illustrative embodiment.

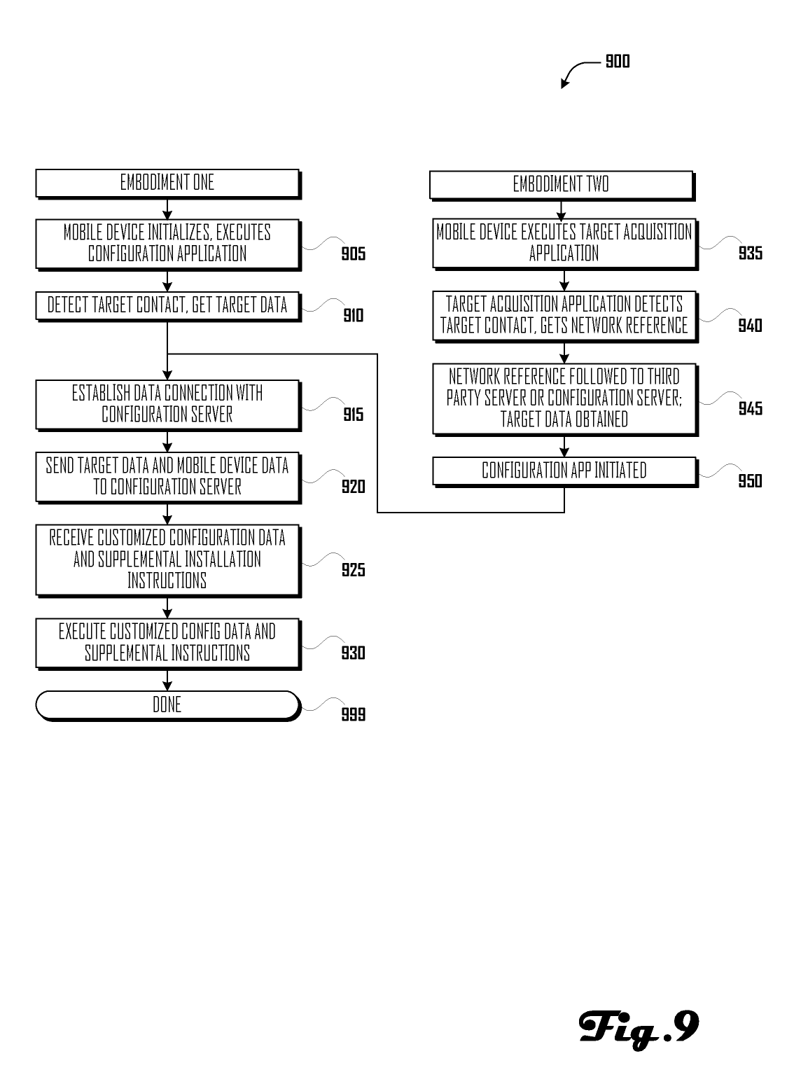

FIG. 7 is a functional block diagram of the Mobile Device Datastore illustrated in the computing device of FIG. 6. The Mobile Device 600 illustrated in FIG. 6 comprises data groups for routines, such as routines for an NFC Application 660, a Configuration Application 900, and a Target Acquisition Application 662. The NFC Application 660 is a software routine which provides NFC functions to the Mobile Device 600, such as allowing the detection or transmission of NFC codes or strings in Targets, for treating NFC codes as triggers for the execution of other software routines, for modifying NFC codes, or for treating NFC codes as data to be used by other software routines. The NFC Application 660 may be part of the Operating System 655. The NFC Application may always be on or may have to be initiated by, for example, the user of the Mobile Device 600, by another routine, or similar. The Configuration Application 900 and the Target Acquisition Application 662 are discussed in relation to FIG. 9. Additional data groups for routines, such as for a webserver and web browser, may also be present on and executed by these devices. Browser routines may provide an interface for interacting with the Configuration Server 200, for example, through a webserver routine (which may serve data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 7 is a functional block diagram of the Mobile Device Datastore illustrated in the computing device of FIG. 6. The components of the Mobile Device Datastore 700 are data groups used by routines and are discussed further herein in the discussion of other of the Figures.

The data groups used by routines illustrated in FIGS. 3, 5, and 7 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Login credentials and local instances of customer and user profiles may be stored in or be accessible to all of the computing devices illustrated in FIG. 1, such as in the Configuration Server Datastore 300, the Display Computer Datastore 500, and the Mobile Device Datastore 700.

The software routines and data groups used by the software routines may be stored and/or executed remotely relative to any of the computers through, for example, application virtualization.

Referring to FIG. 8, the Configuration Display 800 may comprise a physical display, such as a poster, a display board, a screen on which an electronic display may be projected (such as by the Display Computer 400), or an electronic display screen on which an electronic display may be output, such as on or by a tablet computer (as may be provided by the Display Computer 400). The Configuration Display 800 may comprise Configuration Categories 801 such as, for example, Configuration Categories for Wallpaper 805, Applications 810, Games 815, Ringtones 820, Widgets 825, and Accounts 830. Each Configuration Category 801 may comprise multiple choices within the Configuration Category (“Selectable Choices”). For example, as illustrated in FIG. 8, the Wallpaper 805 Configuration Category comprises multiple choices illustrated by blocks, such as block 840, representing Selectable Choices. In this example, each block may represent (display, illustrate, etc.) a different wallpaper which the customer may configure on the Mobile Device 600. Each Selectable Choice within the Configuration Category may further be associated with a Target, such as Target 845. The Target may be a powered or unpowered near-field communication (“NFC”) device, an RFID device, a Bluetooth device, a barcode, a QR code, or another image which is meant to be the subject of optical recognition by, for example, a Target Acquisition Application, such as Target Acquisition Application 900. There may be one Target for each Selectable Choice (much as is illustrated in FIG. 8). Alternatively, the Configuration Display 800 may associate more than one Selectable Choice with one or more Targets. The Configuration Display may comprise one or more Targets in the physical substrate of the Configuration Display 800.

For example, if the Configuration Display 800 is a tablet computer or an electronic display projected on a wall or screen (which tablet computer or projection may be provided by, for example, the Display Computer 400), the Configuration Display 800 may include, for example, checkboxes to indicate which Selectable Choices have been selected (by, for example, the customer) to configure the Mobile Device 600; similar to such checkboxes, the Configuration Display 800 may include an area within the display to which icons representing the Selectable Choices may be dragged or moved, which area indicates that the Selectable Choices have been or are to be selected to configure the Mobile Device 600; the Configuration Display 800 tablet may then comprise a Target (such as one NFC device in the tablet) which is then associated with the selected Selectable Choices. See the discussion of FIG. 11 relating to a process in which the Display Computer, potentially in conjunction with the Display Setup Device 140, configures the Configuration Server and the Configuration Display.

FIG. 9 is a flowchart illustrating embodiments of a Configuration Application routine in which a Mobile Device is configured via interaction with a Configuration Display and the Configuration Server. In FIG. 9, at the start of Embodiment One, at block 905, the Mobile Device 600 has initialized (such as by being turned on for the first time after being distributed to the customer) and executes Configuration Application 900. The Configuration Application 900 may comprise system-level modules for configuration of software and hardware in the Mobile Device 600 which require system-level privileges, such as email and contact information management software applications or account management software applications; the system-level modules may require additional authentication and authorization, such as from the customer or by having been installed on the Mobile Device 600 during the manufacturing process. The Configuration Application 900 may comprise non-system-level modules for configuration of software and hardware in the Mobile Device 600 which do not require system-level privileges, such as for a module for configuration of wallpapers.

Alternatively, at the start of Embodiment Two at block 935, the Mobile Device may execute the Target Acquisition Application 622. The Target Acquisition Application 622 may be, for example, software routines for a QR code reader, a barcode reader, a digital camera in communication with an optical recognition routine, or similar. The Target Acquisition Application 662 may be executed by, for example, the Configuration Application 900 or the Target Acquisition Application 662 may be executed independently of the Configuration Application 900.

At block 910, the Target may be detected by the Configuration Application 900 by, for example, bringing the Mobile Device 600 close enough to the Target for the Mobile Device 600 and/or the Configuration Display 800 to identify the Target and/or the Mobile Device 600 (such as when the Target is an NFC device or the Mobile Device 600 contains an NFC device which is recognized by the Configuration Display 800). Identification of an NFC device requires that the Configuration Application 900 and/or the Configuration Display 800 execute an NFC Application, such as NFC App 660.

The Target may comprise or communicate a string, such as a number or a number-text-character string, such as Target Data 710. The Target Data may be obtained from the Target. The Target Data may be static and not changeable without physically changing the Target, such as a string encoded into a barcode, or dynamic and electronically changeable, such as a string electronically encoded in an NFC device. The Target and Target Data may be maintained and/or updated by a third party, such as Third Party Server 130, which third party may provide the then-current Target Data to, for example, the Configuration Server 200, the Display Computer 400, and/or to the Display Setup Device 140.

At alternative block 940, the Target Acquisition Application 622 may detect a Target contact, such as by taking a picture or image of the Target, and may convert the Target contact into a network reference. The network reference may be, for example, a URL or a string which is used by the Target Acquisition Application 622 to obtain or generate a URL or to otherwise follow a network path to (what is generally) a remote data source. At block 945, the network reference may be followed to, for example, the Third Party Server 130 or the Configuration Server 200 and may be used to obtain Target Data associated with the network reference. At block 950, the Target Data may be a trigger initiating execution of the Configuration Application 900.

The block of detecting the Target and getting the Target Data may be performed in relation to a single Target and/or Selectable Choice or more than one. If performed in relation to more than one, the Target Data for multiple Targets and/or Selectable Choices may be obtained in a batch or in series.

Thus, at block 910 or in alternative blocks 935 through 950, the Configuration Application 900 detects the Target and gets the Target Data.

After acquiring the Target Data, at block 915, the Configuration Application 900 may connect to either the Wireless Network 160 and/or the Network 150 (such as via a Wi-Fi connection) and establish a data connection or other communication with the Configuration Server 200. If the Mobile Device 600 is not yet configured with an account in the Wireless Network 160, the Configuration Application 900 may connect to the Network 150 (such as via a Wi-Fi connection) and/or may be provided with a temporary account in the Wireless Network 160.

At block 920, the Configuration Application 900 transmits the Target Data and Mobile Device Data 705 to the Configuration Server 200, such as to the Configuration Server DB Process 1000, (potentially utilizing an intermediary computing device, such as if the Target Data comprises a reference to a string). The Mobile Device Data 705 may comprise, for example, information associated with the Mobile Device 600, such as non-personally identifiable data, a date-time, a location, the Mobile Device 600 ROM version, a software application build version, a mobile operator or network service provider (such as the provider of the Wireless Network 160), a brand, a model, an operating system version, an SSID used by Wi-Fi in the Mobile Device 600, and a string associated with or obtained from an NFC device in the Mobile Device 600.

At block 925, the Configuration Application 900 receives customized Configuration Data 310 (which may be stored in the Mobile Device 600 as Customized Configuration Data 715) and any supplemental installation or configuration instructions.

At block 930 the Mobile Device executes the Customized Configuration Data and any supplemental installation or configuration instructions to configure the Mobile Device 600.

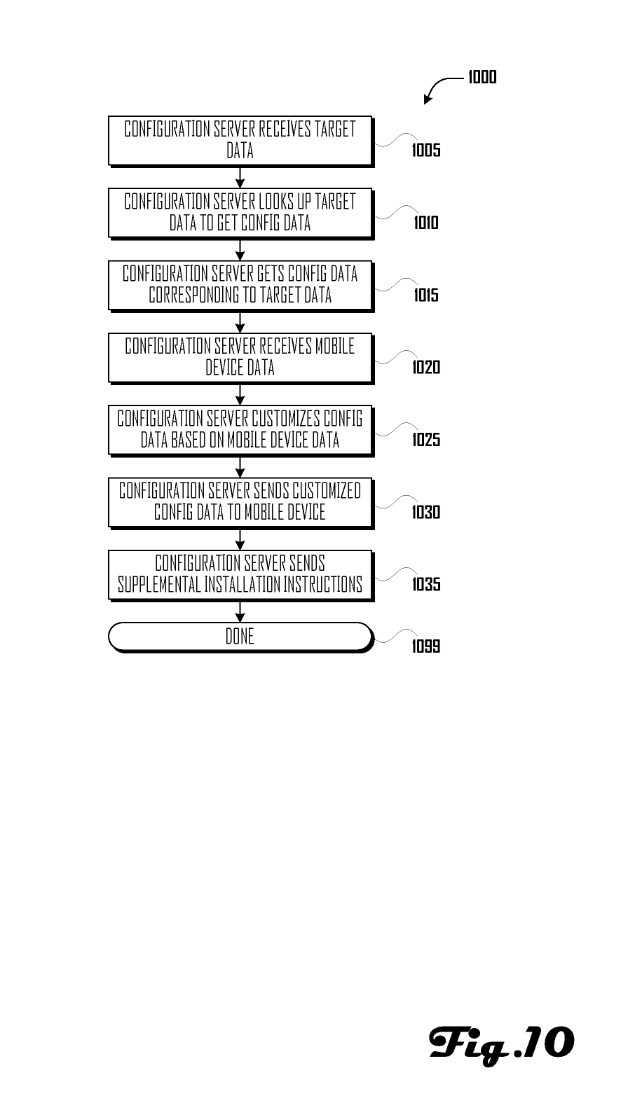

FIG. 10 is a flowchart illustrating a routine in which a Configuration Server DB Process interacts with a Mobile Device to provide the Mobile Device with Configuration Data. At block 1005, the Configuration Server DB Process 1000 receives Target Data from the Configuration Application 900 from a Mobile Device 600. Upon receipt of the Target Data and the Mobile Device Data, the Configuration Server DB Process 1000 may then, at block 1010, look up, such as in Configuration Server Datastore 300, the Target Data to obtain, at block 1015, the Configuration Data 310 corresponding to the Target Data.

At block 1020, the Configuration Server DB Process 1000 may receive Mobile Device Data 705 from the Configuration Application 900, which the Configuration Server DB Process 1000 may save as Mobile Device Data 305. The Configuration Server DB Process 1000 may lookup the Mobile Device Data to obtain Customization Rules 320 corresponding to the Mobile Device, which Customization Rules 320 may, such as at block 1025, be used to customize the Configuration Data for the Mobile Device in question. The Mobile Device Data may be looked up, for example, in an “Asset Management System” maintained by an operator of a Wireless Network 160. For example, if the Configuration Data 310 is a wallpaper and if the Mobile Device Data indicates that the Mobile Device has a high-resolution display and utilizes a particular file format for wallpaper pictures or stores the wallpaper image in a particular location, then the Customization Rules 320 may specify that a high resolution version of the wallpaper will be sent and that the file be transcoded (such as by the Configuration Server 200, by an intermediate computer, or by the Mobile Device) into the specified file format and be stored in the particular location. The customized Configuration Data may be stored at the Configuration Server 200 as Customized Configuration Data 325 records.

At block 1030 the Configuration Server DB Process 1000 sends the Customized Configuration Data to the Mobile Device 600 and the Configuration Application 900 (where it may be received and stored as Customized Configuration Data 715). Alternatively (not shown), the Configuration Server 200 may send a “download later” or similar message or activator to allow the Mobile Device 600 to download the Customized Configuration Data at a later time, such as when the Mobile Device 600 has access to the Network 150 and can download the data without utilizing the Wireless Network 160.

At block 1035 the Configuration Server DB Process 1000 may send supplemental installation or configuration instructions, such as, for example, a “preview” option to allow the Customized Configuration Data to be previewed or other additional instructions.

FIG. 11 is a flowchart illustrating a routine in which a Display Computer configures the Configuration Server and the Configuration Display. At block 1105, the computer executing this process, such as the Display Computer 400, optionally gets data, such as White-Label Data 315, to white-label the services with graphics, text, and other white label information from the White-Label Data 315. At optional block 1110, the Display Computer 400 displays graphics comprising the Configuration Display 800 (discussed in relation to FIG. 8), if the Configuration Display is not a static physical display. At optional block 1115, the Display Computer 400 reconfigures the graphics displayed in block 1110 (including graphics for the Selectable Choices) based on user or customer input, based on the time of day or year (for example, based on sporting events which are then-current), based on the type of Mobile Device (for example, one device may be marketed to gamers, while another is marketed to seniors, while another may have a display which can output high-definition graphics), or based on services the user has purchased (for example, a service package including unlimited data may be associated with a broader set of Selectable Choices); for example, the user or customer input may be to select Configuration Categories 801 to be displayed, to check blocks indicating selections of Configuration Categories or Selectable Choices, or the user or customer input may be to move Configuration Categories or the Selectable Choices to an “active” area of the Configuration Display, or the user or customer input may be to change the images of Configuration Categories or Selectable Choices projected or displayed on a display board or screen, or the user input may be to print images of Selectable Choices, which printed images are to be secured to a physical display board.

At block 1120, the Target Data for the Targets is obtained or designated. For example, if the Configuration Display is a static physical display comprising Targets comprising NFC devices embedded in the Configuration Display, the Target Data may be obtained by contacting (or becoming proximate to) the Targets with the Display Setup Device 140. Alternatively, if the Configuration Display comprises a set of Targets with Target Data which is already known and stored, such as in the Target Data 330 record, an identifier of the Configuration Display and/or of the stored Target Data 330 may be communicated to, for example, the Configuration Server 200. Alternatively, if the Targets comprise QR, barcodes, or other images which are to the be subject of optical recognition, the Target Data may be obtained by taking a picture or image of the Target with, for example, a Target Acquisition Application. Alternatively or in addition, the Target Data may be designated, such as by configuring an NFC device in the Configuration Display with the desired Target Data (such as a string). Designation of the Target Data may be included in block 1110 or 1115 (such as if the Target is a QR, barcode, or other image).

At block 1125, the Target Data obtained by the Display Computer 400 is associated with the Configuration Categories and/or Selectable Choices, such that the Configuration Data 310 associated with Selectable Choices is then associated with the Target Data. This association process may involve an intermediate block in which the Display Computer 400 utilizes or provides Configuration Data References 510 which correspond to the Configuration Categories and/or Selectable Choices displayed at block 1115, which Configuration Data References 510 identify the Configuration Data 310 records at the Configuration Server 200, such that the Configuration Server 200 can associate the Target Data with the Configuration Data 310 records.

FIG. 12 is a flowchart illustrating a routine in which a Mobile Device interacts with a Configuration Display without mediation of a Configuration Server. At block 1205, the Mobile Device 600 initializes and executes the Configuration Application 900. Blocks 1210 through 1225 are optional, for embodiments which involve a Display Computer 400 (these blocks may not be necessary of a Configuration Display is provided which already is compatible with the Mobile Device 600). At block 1210, the Mobile Device 600 establishes a data connection with the Display Computer 400. At block 1215, the Mobile Device 600 sends Internal Configuration Options 720 to the Display Computer 400; the Internal Configuration Options 720 may comprise graphics, text, and similar which describe the configuration options which are available within the Mobile Device 600; the Internal Configuration Options 720 may comprise Configuration Categories and/or Selectable Choices similar to those illustrated in FIG. 8, such as, for example, wallpapers, applications, ringtones, and accounts. At block 1220, the Display Computer may output the Internal Configuration Options 720 on a Configuration Display which comprises Targets and Target Data. At block 1225, the Display Computer associates the Target Data in the Configuration Display with the Internal Configuration Options 720 and sends the association to the Mobile Device 600; as noted above, in an alternative embodiment in which there is no Display Computer in this process, a pre-configured Configuration Display may be utilized and the Mobile Device 600 may be pre-programmed to associate the Target Data within the Configuration Display with the Internal Configuration Options 720. At block 1230, the Mobile Device 600 detects contact with a Target and gets the Target Data, much as described above (which may include obtaining the Target Data directly from the Configuration Display or from a third party computer which supports the Configuration Display). At block 1235, the Mobile Device 600 identifies the Internal Configuration Option 720 associated with the Target Data. At block 1240, the Mobile Device 600 executes the identified Internal Configuration Option.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A computer implemented method of configuring a mobile computing device, the method comprising:
detecting, with the mobile computing device, proximity to a configuration display;
obtaining a first configuration option identifier from the configuration display;
transmitting the first configuration option identifier and information regarding the mobile computing device to a configuration server;
receiving first configuration data from the configuration server; and
configuring the mobile computing device utilizing the first configuration data.

2. The method according to claim 1, wherein the configuration display comprises a physical display and the first configuration option identifier.

3. The method according to claim 2, wherein the first configuration option identifier is communicated via at least one of a near-field communication device, an RFID device, and an image.

4. The method according to claim 3, wherein the image comprises one of a QR code and a bar code.

5. The method according to claim 4, further comprising photographing the image with the mobile computing device, transmitting the photograph of the image to an image-processing server, and receiving the first configuration option identifier from the image-processing server.

6. The method according to claim 2, wherein the configuration display comprises more than one configuration option for the mobile computing device, which configuration options are arranged in configuration categories, and wherein each configuration option is associated with a distinct configuration option identifier.

7. The method according to claim 6, wherein the configuration categories comprise at least one of wallpapers, mobile computing device applications, games, ringtones, widgets, and accounts.

8. The method according to claim 6, wherein the configuration categories on the configuration display comprise a graphical identifier of the configuration option.

9. The method according to claim 1, wherein the configuration server performs a method comprising:
receiving the transmitted first configuration option identifier from the mobile computing device;
looking up the first configuration option identifier in a database to obtain the first configuration data, which first configuration data is associated in the database with the first configuration option identifier; and
transmitting to the mobile computing device the first configuration data.

10. The method according to claim 9, wherein the method performed by the configuration server further comprises receiving the information regarding the mobile computing device and customizing the first configuration data according to the information regarding the mobile computing device.

11. The method according to claim 10, wherein the information regarding the mobile computing device comprises at least one of a date-time, a location, a ROM version, a software application build version, a mobile operator or network service provider, a brand, a model, an operating system version, an SSID, and a string associated with or obtained from an NFC device in the mobile computing device.

12. The method according to claim 10, wherein customizing the first configuration data according to the information regarding the mobile computing device comprises selecting a graphic based on the display resolution of the mobile computing device.

13. The method according to claim 1, wherein the configuration display comprises a projected display and the first configuration option identifier, wherein the first configuration option identifier is a string communicated via at least one of a near-field communication device in the display surface, an RFID device in the display surface, and an image in the projected display.

14. The method according to claim 1, wherein the projected display is projected by a display computer and the projected display is projected onto a surface comprising the first configuration option identifier.

15. The method according to claim 14, wherein the display computer performs a method comprising:
receiving display graphics for more than one configuration option for the mobile computing device;
associating the first configuration option identifier with at least one of the display graphics.

16. The method according to claim 15, further comprising updating the display graphics.

17. The method according to claim 15, wherein the display computer is the mobile computing device.

18. A computer implemented method of configuring a mobile computing device, the method comprising:
in a server, detecting proximity of a mobile computing device to a configuration display;
obtaining a proximity identifier from the mobile computing device;
determining a configuration option displayed on the configuration display at the time when the proximity identifier from the mobile computing device was obtained;
determining configuration data associated with the determined displayed configuration option; and
transmitting the determined configuration data to the mobile computing device.

19. A non-transient computer-readable storage medium having stored thereon instructions that, when executed by a processor in a mobile computing device, configure the processor to:
detect proximity to a configuration display;
obtain a first configuration option identifier from the configuration display;
transmit the first configuration option identifier and information regarding the mobile computing device to a configuration server;
receive first configuration data from the configuration server; and
configure the mobile computing device utilizing the received first configuration data.

20. A computer implemented method of configuring a mobile computing device, the method comprising:
transmitting a set of multiple configuration options to a display computer;
receiving, from the display computer, an association between the transmitted configuration options and configuration option identifiers;
detecting, with the mobile computing device, proximity to a configuration display output by the display computer;
obtaining a first configuration option identifier from the configuration display;
selecting from among the configuration options utilizing the obtained first configuration option identifier and the received association between the transmitted configuration options and configuration option identifiers; and
configuring the mobile computing device utilizing the selected configuration option.

21. The method according to claim 20, further comprising obtaining the multiple configuration options from a datastore internal to the mobile computing device.

22. A non-transient computer-readable storage medium having stored thereon instructions that, when executed by a processor in a mobile computing device, configure the processor to:
transmit a set of multiple configuration options to a display computer;
receive, from the display computer, an association between the transmitted configuration options and configuration option identifiers;
detect, with the mobile computing device, proximity to a configuration display output by the display computer;
obtain a first configuration option identifier from the configuration display;
select from among the configuration options based on the obtained first configuration option identifier; and
configure the mobile computing device utilizing the selected configuration option.
